(19) United States
(12) Patent Application Publication
(10) Pub. No.: US 2009/0266275 A1
(43) Pub. Date: Oct. 29, 2009

(54) SHIPPING SYSTEM FOR OBJECTS SUCH AS AN AIRCRAFT ENGINE

(75) Inventor: Perry Matthew Feeney, Arvada, CO (US)

Correspondence Address: DYKEMA GOSSETT PLLC, 39577 WOODWARD AVENUE, SUITE 300, BLOOMFIELD HILLS, MI, 48304-5086, US

(73) Assignee: EATON CORPORATION, Cleveland, OH (US)

(21) Appl. No.: 12/108,580

(22) Filed: Apr. 24, 2008

(51) Int. Cl. B65D 85/68; B64F 5/00

(52) U.S. Cl. 108/55.1; 206/319; 206/386; 410/44

(57) ABSTRACT

An embodiment of a shipping system for transporting an object is provided. In an embodiment, a shipping system is provided that includes a frame assembly, a cradle assembly, and a mechanism for simultaneously rotating and translating the cradle assembly relative to the base of the frame assembly. The frame assembly includes a base. The cradle assembly is connected to the frame assembly, and includes a forward member for securing a forward portion of the transported object (e.g., an aircraft engine) and an aft member of securing an aft portion of the object being transported.

### TECHNICAL FIELD

The present invention relates to a shipping system providing a means for transporting an object, such as an aircraft engine. The invention further relates to a method for transporting an object, such as an aircraft engine.

### BACKGROUND

In the aircraft industry, it is often necessary to transport objects, such as an aircraft engine, from one location to another. However, aircraft engines are generally very large and their size can restrict the available shipping options. For instance, many engines can be too large to fit through certain cargo doors, such as the door of a freighter aircraft. Consequently, there is a need for shipping systems that would permit the shipment of a large object, such as an aircraft engine, that would otherwise normally not be able to fit through a cargo door.

### SUMMARY

An embodiment for a shipping system for transporting an object is provided according to aspects of the invention. In an embodiment, a shipping system is provided that includes a frame assembly, a cradle assembly, and a mechanism for simultaneously rotating and translating the cradle assembly relative to the base of the frame assembly. The frame assembly includes a base. The cradle assembly is connected to the frame assembly, and includes a forward member for securing a forward portion of the transported object (e.g., an aircraft engine) and an aft member of securing an aft portion of the object being transported.

### BRIEF DESCRIPTION OF THE DRAWINGS

Embodiments of the invention will now be described, by way of example, with reference to the accompanying drawings, wherein:

FIG. 1 is perspective view of a shipping system according to an embodiment of the invention;

FIG. 2 is perspective view of a shipping system according to an embodiment of the invention with an aircraft engine shown mounted to the system;

FIG. 3 is another perspective view of the shipping system and aircraft engine shown in FIG. 2;

FIG. 4 is a front elevation view of the shipping system and aircraft engine shown in FIG. 2;

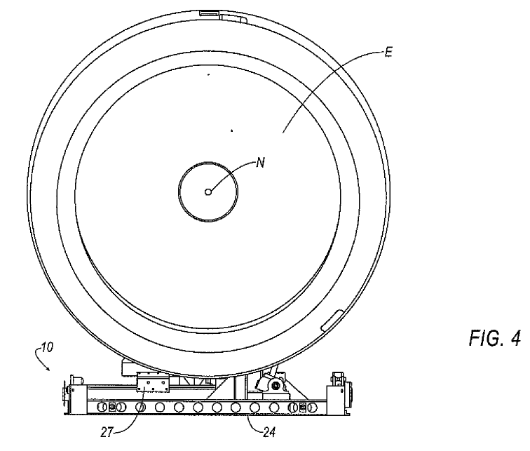

FIG. 5 is a rear elevation view of the shipping system and aircraft engine shown in FIG. 2;

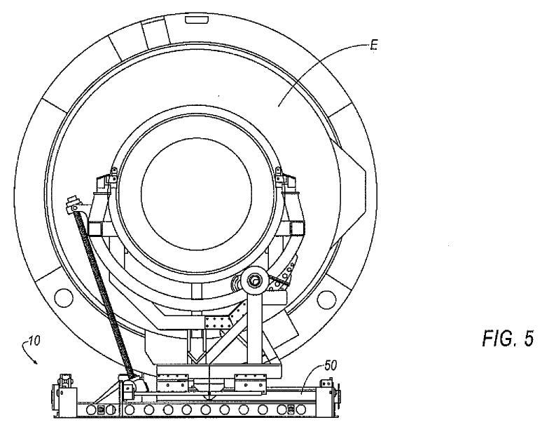

FIG. 6 is another perspective view of the shipping system and aircraft engine shown in FIG. 2, the engine shown in a different position;

FIG. 7 is a different perspective view of the shipping system and aircraft engine shown in FIG. 6;

FIG. 8 is a general representation of a front elevation view of a shipping system and aircraft engine according to an embodiment of the invention; and

FIG. 9 is a general representation of an aft elevation view of a shipping system of the type illustrated in FIG. 8.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

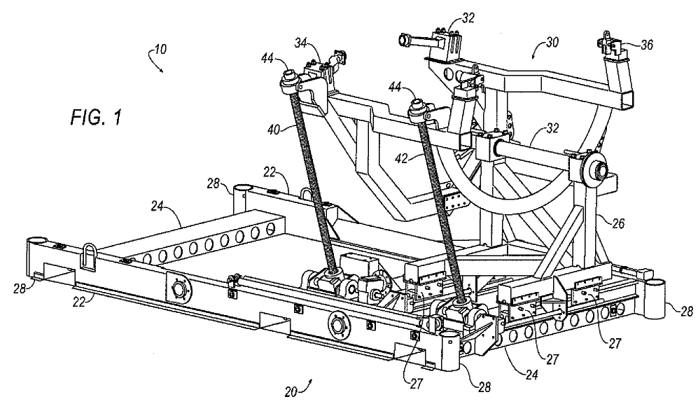

An embodiment of a shipping system (or “shipping assembly”) 10 is generally shown in FIG. 1. Assemblies of the type disclosed in the present teachings may be may be used for holding and/or transporting objects, including large objects such as aircraft engines. The shipping system 10 includes a frame assembly 20 and a cradle assembly 30 connected to the frame assembly 20.

The frame assembly 20 includes one or more longitudinal frame members 22. In the illustrated embodiment, frame assembly 20 includes a pair of laterally-spaced longitudinal frame members 22. The longitudinal frame members 22 may be connected by one or more transverse support members 24. As illustrated, the longitudinal frame members 22 and the transverse support members 24 may be connected to form all or part of a base for the frame assembly 20. The frame assembly 20 may further include a hinge weldment 26 that is connected, directly or indirectly, to the base of the frame assembly 20 (for example, to one or more transverse support members 24). In embodiments of the invention, the hinge weldment 26—at least in part—supports a portion of the cradle assembly 30. As generally illustrated, hinge weldment 26 can be configured to receive a portion (e.g., shaft 32) of the cradle assembly so as to permit at least an aft (or comparatively more rearward) portion of the cradle assembly 30 to rotate or “rock” about an axis (e.g., the axis or centerline associated with shaft 32).

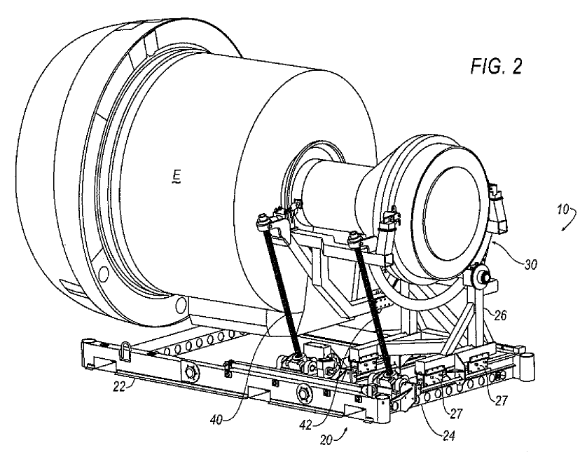

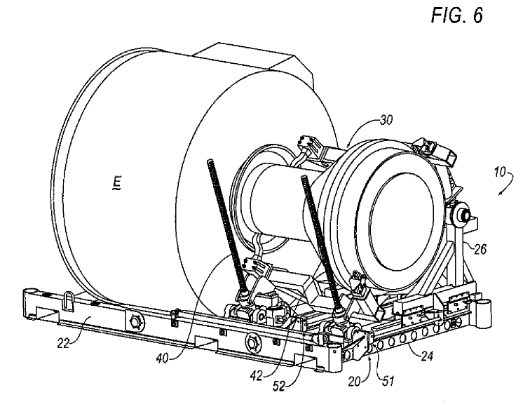

Further, the frame assembly 20 is configured so that hinge weldment 26 can move laterally between a pair of laterally-spaced longitudinal frame members 22. For example, without limitation, one or more roller shoes 27 may facilitate the movement of the weldment 26 along or about a path or track provided between laterally-spaced longitudinal frame members 22. Non-limiting examples of the lateral positioning of the hinge weldment 26 are generally shown in FIG. 2, which illustrates a hinge weldment 26 at a first position with respect to the laterally-spaced longitudinal frame members 22, and FIG. 6, which depicts the hinge weldment 26 at a second position that is in closer proximity to one of the two identified laterally-spaced longitudinal frame members 22.

Frame assembly 20 may additionally include a plurality of mounts, such as the illustrated caster mounts 28. The mounts, which may be configured in various alternate forms, can be used to mount or attach additional movement-facilitating members, such as casters or wheels (not shown), to facilitate or improve the movement of the shipping system 10 on various surfaces. Such movement-facilitating members may generally be attached, retracted, or removed, as may be necessary or desirable. Other conventional structures commonly included with frame assemblies, such as shock mounts, shock pads, steering bars, tow bars, and pneumatic wheel sets, may also be included with the frame assembly 20.

As illustrated, cradle assembly 30 may further include a forward securing member 34 and an aft securing member 36. As shown further in subsequent drawing figures, the forward member 34 may be configured to secure a forward portion of an aircraft engine, and the aft member 36 may be configured to secure an aft (i.e., a comparatively more rearward) portion of an aircraft engine.

The frame assembly 20 further includes a means for simultaneously rotating and translating a cradle assembly 30 relative to a base of a frame assembly. That is, the invention can, among other things, provide for the securing of a large object (e.g., an aircraft engine) having a centerline and the movement of such object in a manner that substantially maintains the centerline position while rotating the engine around a point that is not on the centerline by as much as 50° or more. Such controlled rotation can permit shipment of a large object that, but-for such controlled rotation, might be too large to fit through a “standard” or conventional cargo opening provided with various means for transportation (e.g., a freighter aircraft).

A general representation of an object for transport in connection with the system is provided. More specifically, an object comprising an engine E, is shown in FIG. 2 and other subsequent figures. However, while an engine is shown in some detail, the present invention can have applications for various other objects that might be transported using such a frame-cradle configuration.

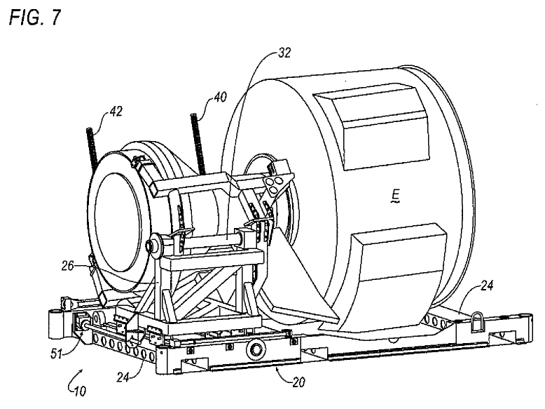

In an embodiment of the invention, the associated mechanism for simultaneously rotating and translating the cradle assembly 30 may comprise a plurality of rotational jacks 40,42 that are operatively coordinated or paired with other (e.g., horizontal) jacks. In accordance with teachings of the invention, the two sets of jacks may be configured (i.e., timed) to move at different rates to provide a desired movement (e.g., parabolic movement) of the cradle—and hence, a secured object such as engine E. As generally illustrated in the embodiments shown in FIGS. 6 and 7, a pair of rotational jacks 40,42 may be separately paired with a horizontal jack. For example, rotational jack 42 may be paired with horizontal jack 51, and rotational jack 40 may also be operatively paired with a second horizontal jack 52, which as illustrated may be substantially parallel to horizontal jack 51. It is noted that the “horizontal” jacks are not necessarily required to be horizontal and other orientations may be provided. In the illustrated embodiment, the rotational jacks 40,42 move the cradle assembly about the hinge weldment 26, and the horizontal jacks move the hinge weldment 26 along a path (e.g., along a path associated with roller shoes). It is noted that while the rotational jacks and horizontal jacks are shown being used in pairs, in other embodiments, such jacks may be used singly.

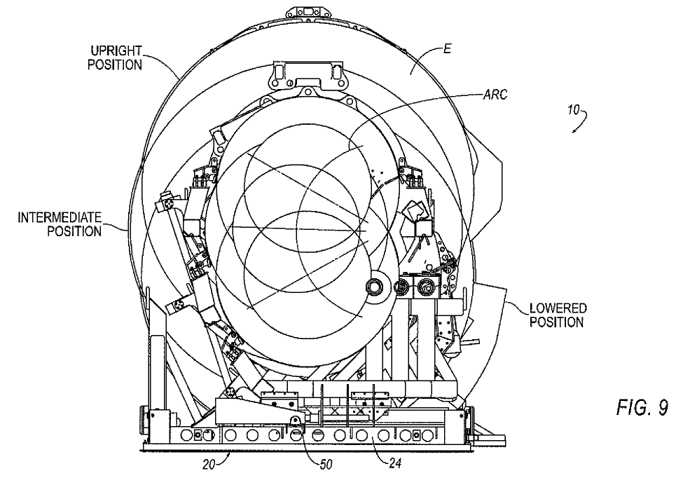

As generally illustrated in FIG. 9, the frame assembly 20 may include an input device, e.g., input shaft 50. Referring once again to FIG. 2, rotational (or screw) jacks 40,42 can be configured and connected to a common input (e.g., a shaft associated with an input shaft 50) such that the rotational screw jacks 40, 42 and the horizontal jacks 51, 52 can move (i.e., rotate) at different rates. As shown, travel nuts 44 may be provided in connection with the screw jacks, and as generally illustrated in various figures, may move along screw jacks 40, 42. In an embodiment of the invention, an operator can provide an input torque to turn an input shaft 50. The provision of torque to the input shaft 50 may involve electrical power, hydraulics, pneumatics, and/or user-generated power.

In FIG. 2, the engine E is shown connected to the cradle and in what may be referred to as an “UP” position. Again, by providing input (torque and/or linear movement) from an input device, e.g., input shaft 50, the connected screw jacks (e.g., screw jacks 40,42), which are tied to the common input but move at different rates, can be used to linearly move and rotate the secured object (e.g., engine E), in this case both down and counterclockwise, to a shipping position. An illustration of such a shipping position is generally shown in FIG. 6—in which the weldment 26 is shown moved linearly (to the right of the initial position looking in the aft direction) and cradle assembly 30 is shown rotated/turned with the respective travel nuts 44 associated with screw jacks 40, 42 now positioned closer to the base of frame assembly 20.

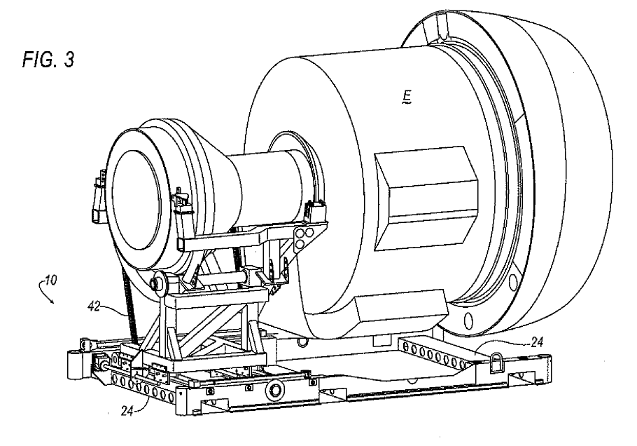

An opposite side perspective view of a shipping assembly 10 and engine E shown in FIG. 2 is generally illustrated in FIG. 3. Similarly, FIG. 7 generally illustrates the shipping assembly generally illustrated in FIG. 6 shown from the opposite side.

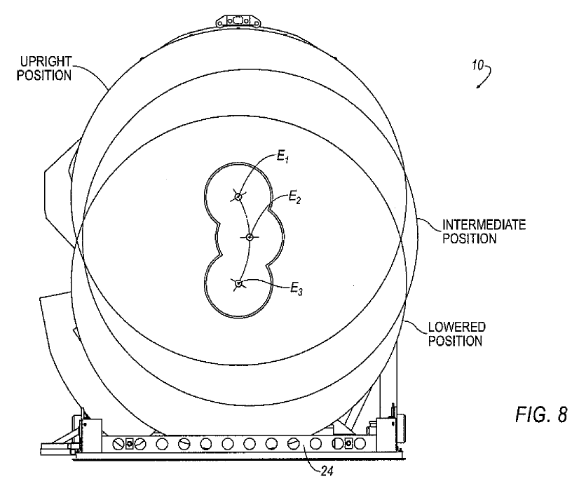

FIG. 8 is a representation of a forward-looking-aft view of an embodiment of the shipping assembly 10 and associate secured object—i.e., engine E. The representation depicts the engine E in three different positions that are generally identified as an “upright position,” an “intermediate position,” and a “lowered position.” As generally illustrated, the system 10—in moving the cradle assembly from an “upright” to a “lowered” position—causes the Engine E to move along a substantially parabolic arc (e.g., the arc formed by E₁ to E₂ to E₃). FIG. 9 is a general representation of an aft elevation view of a shipping system as illustrated in FIG. 8, with the previously noted arc generally designated.

For embodiments of the system, in an upright position the secured object may be level and can be sufficiently elevated to permit work, installation, maintenance, etc. As previously discussed and as generally illustrated, the object can then be “rolled”—for e.g., by 50 or more degrees—in a clockwise direction and lowered by as much as several feet to better permit shipment. Moreover, embodiments of the system permit the object to remain centered with respect to the base—which can be important for both transport and later installation.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A shipping system for transporting an object, the shipping system comprising:
a frame assembly including a base;
a cradle assembly connected to the frame assembly, the cradle assembly including a forward member for securing a forward portion of said object and an aft member for securing an aft portion of said object; and
a mechanism connected to the cradle for simultaneously rotating and translating the cradle assembly relative to the base of the frame assembly.

2. The system of claim 1, wherein the mechanism includes a first screw and a second screw.

3. The system of claim 2, wherein the first and second screws are timed to provide for a parabolic movement path of the cradle assembly.

4. The system of claim 1, wherein the mechanism includes an input device configured to provide input for both rotating and translating the cradle assembly.

5. The system of claim 4, wherein the input device comprises a common input shaft.

6. The system of claim 4, wherein the input device comprises a torque-generating device.

7. The system of claim 4, wherein the input device is connected to screws that are configured to rotate at different rates.

8. The system of claim 7, including one or more travel nuts that move along one or both of the screws.

9. The system of claim 4, wherein an input torque is provided to the input device.

10. The system of claim 9, wherein the input torque is provided, at least in part, by electrical power, hydraulics, pneumatics, or user-generated power.

11. The system of claim 1, wherein the frame assembly comprises at least two laterally-spaced longitudinal frame members.

12. The system of claim 11, wherein the frame members are connected by one or more transverse support members.

13. The system of claim 1, including a hinge weldment connected to the base of the frame assembly, the weldment supporting at least a portion of the cradle assembly.

14. The system of claim 13, wherein the weldment is configured to receive a portion of the cradle assembly to permit at least an aft portion of the cradle assembly to rotate or rock about an axis of a shaft of the cradle assembly.

15. The system of claim 13, wherein the hinge weldment is configured to move laterally between a pair of laterally-spaced longitudinal frame members.

16. The system of claim 13, including one or more roller shoes to facilitate the movement of the weldment along or about a path or track provided between laterally-spaced longitudinal frame members.

17. The system of claim 1, the system including at least one mount configured to mount or attach at least one movement-facilitating member.

18. The system of claim 1, wherein the cradle assembly includes a forward securing member and an aft securing member.

19. The system of claim 18, wherein the forward securing member is configured to secure a forward portion of an aircraft engine, and the aft securing member is configured to secure an aft portion of the aircraft engine.

20. The system of claim 1, wherein said object has a centerline, and the system substantially maintains the centerline position of said object while rotating the object around a point that is not on the centerline by at least 50°.

21. A shipping system for transporting an aircraft engine, the shipping system comprising:
a frame assembly including a base;
a cradle assembly connected to the frame assembly, the cradle assembly including a forward member for securing a forward portion of said aircraft engine and an aft member for securing an aft portion of said aircraft engine; and
a means for simultaneously rotating and translating the cradle assembly relative to the base of the frame assembly.

22. A shipping system for transporting an aircraft engine, the shipping system comprising:
a frame assembly including at least two laterally-spaced longitudinal frame members and at least one transverse support member;
a cradle assembly connected to the frame assembly, the cradle assembly including a forward member for securing a forward portion of said aircraft engine and an aft member for securing an aft portion of said aircraft engine;
a mechanism for simultaneously rotating and translating the cradle assembly relative to the base of the frame assembly, the mechanism including a first screw and a second screw that are timed to provide for a parabolic movement path of the cradle assembly; and
an input device configured to provide input for both rotating and translating the cradle assembly.

23. The system of claim 22, including a hinge weldment connected to the frame assembly, the weldment supporting at least a portion of the cradle assembly.

24. The system of claim 23, wherein the weldment is configured to receive a portion of the cradle assembly so as to permit at least an aft portion of the cradle assembly to rotate or rock about an axis associated with a shaft associated with the cradle assembly.

25. The system of claim 23, wherein the hinge weldment is configured to move laterally between a pair of laterally-spaced longitudinal frame members.
